(19) United States
(12) Patent Application Publication
(10) Pub. No.: US 2006/0192374 A1
(43) Pub. Date: Aug. 31, 2006

(54) Airbag equipped vehicle enclosures

(76) Inventor: William Redvers Belisle, New Orleans, LA (US)

Correspondence Address: WILLIAM REDVERS BELISLE, P.O. BOX 792653, NEW ORLEANS, LA, 70179, US

(21) Appl. No.: 11/067,561

(22) Filed: Feb. 28, 2005

(51) Int. Cl. B60R 21/02

(52) U.S. Cl. 280/748

(57) ABSTRACT

Portals with covers or seals, environmental control systems, bullet-, fire-, radiation-, explosion-proof, and chemical resistant materials are part of an airbag equipped automotive or electric vehicle enclosure that has mechanized raising and lowering device(so, shields between the riders, passengers, or loads and vehicle, lighting devices, mirrors, enclosure wipers or cleaners, and defogging, deicing, and water removing or applying devices. The portal covers or seals may be opened or closed in different ways and the environmental control systems may be adjusted to warm, cool, or may maintain desired enclosure temperature or air quality. The enclosure protects the rider(s), passenger(s), load(s), and vehicle from bullets, fire, radiation, and explosion and is also chemical resistant. The enclosure may be raised or lowered manually or mechanically, contains shields between the rider(s), or passenger(s) and the vehicle, and is equipped with lighting, mirror, wiper, defogging, deicing, and water removing or applying devices. The attachment mechanism for attaching the enclosure to the vehicle includes a ‘permanent or temporary’ attachment provision. These additions to the airbag equipped enclosure for automotive or electric vehicles allows for or provides entrance and exiting into and from the enclosure, environmental control or maintenance within or about the enclosure, protection from various types of approaching objects and harmful agents, easy methods of opening, protection from vehicle components in case of collisions or accidents, and accidents, and additional vision enhancement and enclosure cleaning capabilities.

### CROSS-REFERENCES TO RELATED APPLICATIONS:

1. Belisle, W. R., 2000. “Fairing and Fairingless Enclosures for Two-, Three-, and Four- Wheel Automotive vehicles/Riders/Passengers/Loads (FFE)”
2. Kelley, R. F., 1976. “Transparent Cover with Connecting Devices for Motorcycles and Riders”.
3. Bothwell et al., 1997. “Motorcycle with an Enclosed Body and Support Assembly”.
4. Bunau-Varilla, E., 1915. “Wind Dividing Apparatus for Transport Vehicles with Kinematics Equilibrium”.
5. Stobar, L. T., 1978. “Motorcycle Fairing-Windshield Assembly”.
6. Johnson, et al., 1982. “Motorcycle Fairing Body Extender”.
7. Yoshirnura et al., 1994. “Fairing for a Motorcycle”.
8. Buell,E., 1990. “Motorcycle Fairing”.
9. Yamada et al., 1990. “Exterior Shell of a Motorcycle Front Fairing Unit”.
10. Jaeke, V., 1977. “Motorcycle Fairing”.
11. Hickman, J. S. 1982. “Motorcycle Fairing”.
12. Sakuma, T. S., 1998. “Motorcycle with Fairing”.

### STATEMENT REGARDING FEDERALLY SPONSORED RESEARCH OR DEVELOPMENT

N/A

### REFERENCE TO A MICROFICHE APPENDIX

N/A

### BACKGROUND OF THE INVENTION

1. Field of the Invention/Technical Field

The following is ‘A statement of the field of art to which the invention pertains’:

1. U.S. Class 180

Field of Search: 180/219; 180/271-180/281; 180/274

2. U. S. Class 296

Field of Search: 296/78.1; 296/84.1; 296/211; 296/188; 296/200; 296/201; 296/35.1

3. U.S. Class 280

Field of Search: 280/728.1; 280/728.2

2. Description of the Related Art

Prior art describes enclosure-type apparati for some automotive vehicles such as motorcycles (Belisle, 200; Bothwell et al., Kelly, 1976; and Bunau-Varilla, 1915). These prior arts are associated with environmental parameters such as weather and air as well as safety. My prior invention regarding automotive vehicle enclosures also describes increased safety by providing airbag systems for such enclosures. These prior arts do not specifically claim 1) portal covers or sealing devices which opens or closes about the enclosure, 2) mechanical environment-control systems for controlling the environment within or about the enclosure, 3) bullet-proof enclosures, 4) powered/assisted mechanized/mechanical raising and lowering of the enclosure, 5) shielding between the rider(s) and cargo and the vehicle, and 6) a ‘permanent or temporary’ enclosure attachment to the vehicle.

Some of the prior art describes lighting devices, mirrors, and water (or other material) removing or water (or other material) repelling devices for automotive vehicle enclosures.

The present invention overcomes these short comings by providing portal covers or sealing devices about an enclosure for automotive or electrical vehicles which may open or close, include heating, cooling, and air quality control systems for controlling or maintaining the environment within or about the enclosure, bullet-proof, fire-proof, radiation-proof, chemical-resistant, or explosion-proof enclosures, shielding between the rider(s) and cargo and the vehicle, and a ‘permanent or temporary enclosure attachment to the vehicle. The present invention also provides lighting devices, mirrors, and water or other material repelling devices for airbag equipped automotive or electrical vehicle enclosures. The provisions of the present invention also include and a structure or frame-type enclosure for automotive or electrical vehicles which may be comprised of airbag safety systems made about the enclosure.

### BRIEF SUMMARY OF THE INVENTION

It is the objective of the invention to provide covered or sealed portals for entering or exiting an airbag equipped enclosure for automotive or electrical vehicles, environment control systems for an airbag equipped enclosure for automotive or electrical vehicles, bullet-, fire-, radiation-, chemical-, and explosion-proof materials for which an airbag equipped enclosure for automotive or electrical vehicles are made, mechanized/assisted raising and lowering of an airbag equipped enclosure for automotive or electrical vehicles, shielding between the rider(s) and cargo and the vehicle for an airbag equipped enclosure for automotive or electrical vehicles to the vehicle (or to attachment about the vehicle), lighting devices, mirrors, vision enhancement devices for an airbag equipped enclosure for or electrical automotive vehicles, and wiper devices, and defogging, deicing, and water removal/application devices for an airbag equipped enclosure for automotive or electrical vehicles. It is also the objective of the invention to provide non-substantially transparent, partially enclosing (not including ‘fairing’ prior art), and “structure or frame-type” airbag equipped enclosures for automotive and electrical vehicles.

### BRIEF DESCRIPTION OF SEVERAL VIEWS OF THE DRAWINGS

The present invention will be more fully understood by reference to the following brief description there of when read in conjunction with the attached drawings, and wherein:

FIG. 1. Side view of an airbag equipped vehicle enclosure attached to a two-wheeled vehicle showing the general locations of several features.

FIG. 2. Side view of an airbag equipped vehicle enclosure attached to a two-wheeled vehicle showing (17) the bullet-, fire-, chemical-, radiation-, or explosion-proof shell.

### DETAILED DESCRIPTION OF THE INVENTION

(References are to Illustrations)

The present invention consists of components for, descriptions of, and additions to an airbag equipped enclosure for automotive or electric vehicles including covers or seals for portals located about the enclosure which open and close in various ways, environmental control systems for controlling the temperature and air quality within or about the enclosure, protection of the enclosure and occupants from bullets, fire, radiation, chemical, explosions, and other hazardous agents, mechanized/powered/assisted raising and lowering of the enclosure, protective shields between the rider(s), passenger(s), and load(s) and the vehicle, ‘permanent and temporary’ attachment mechanisms for attaching the enclosure to the automotive vehicle, and lighting, vision or seeing enhancing, wiper, defogging, deicing, and water removing and applying devices. The present invention also consists of ‘structure or frame-type’ airbag equipped enclosures for automotive or electric vehicles.

Considering entering and exiting the enclosure, the present invention will provide a much improved, easier, and more convenient way to enter and exit the enclosure by providing covers and seals (doors and windows) for portals located about the enclosure. The invention provides environmental control systems which may be activated in situations of undesirable temperature or air quality within or about the enclosure. The invention is made of material which provides protection of the rider(s), passenger(s), load(s), and vehicle from bullets, fire, radiation, chemicals, explosions, and other hazardous agents. Considering lifting the enclosure for entering and exiting purposes, the invention provides a mechanized (hydraulic, pneumatic, electronic, etc.) way to raise and lower the enclosure. Considering collision or accidental situations, the invention provides shields between the rider(s), passenger(s), and load(s) and the vehicle. The invention is made such that sufficient structure or frame entirely or partially encloses the vehicle and is made to provide necessary support for airbag systems and other features of the invention. Considering the fact that the use of the enclosure such that it may be of a permanent or temporary type. Considering unwanted substances or materials on or about the enclosure as well as enhanced and required visibility, the invention provides lighting, vision enhancing, wiper, defogging, deicing, and water removing and applying devices.

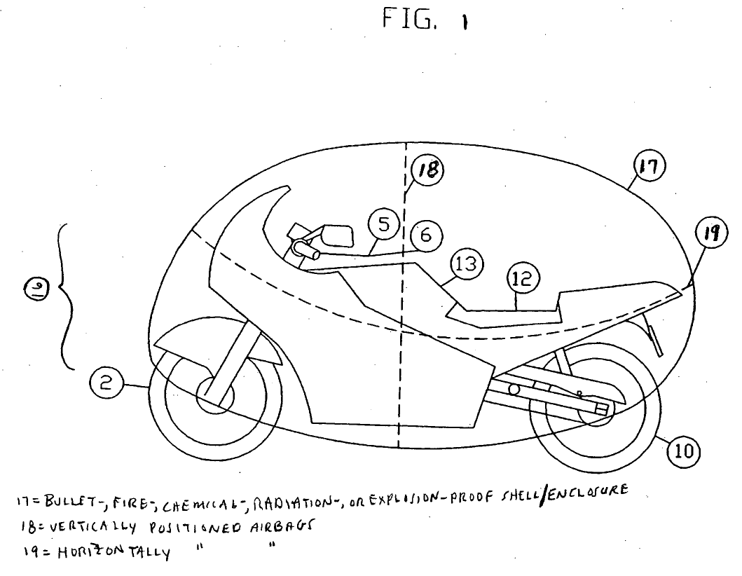

FIG. 1. Side view of an airbag equipped vehicle enclosure attached to a two-wheeled vehicle showing (17) the bullet-, fire-, chemical-, radiation-, or explosion-proof shell, ‘structure or frame-type’ enclosure and the general locations of (2) the front end of the motorcycle and the tire, (5) the handlebar grip, (6) the handlebar, (10) the back end of the motorcycle and the tire, (12) the motorcycle seat, (13) the gas tank, (18) the vertically positioned airbags, and (19) the horizontally positioned airbags. The lower portion of the frame or enclosure is not required to be transparent. These features are also associated with other vehicles including but not limited to three- and four-wheeled vehicles.

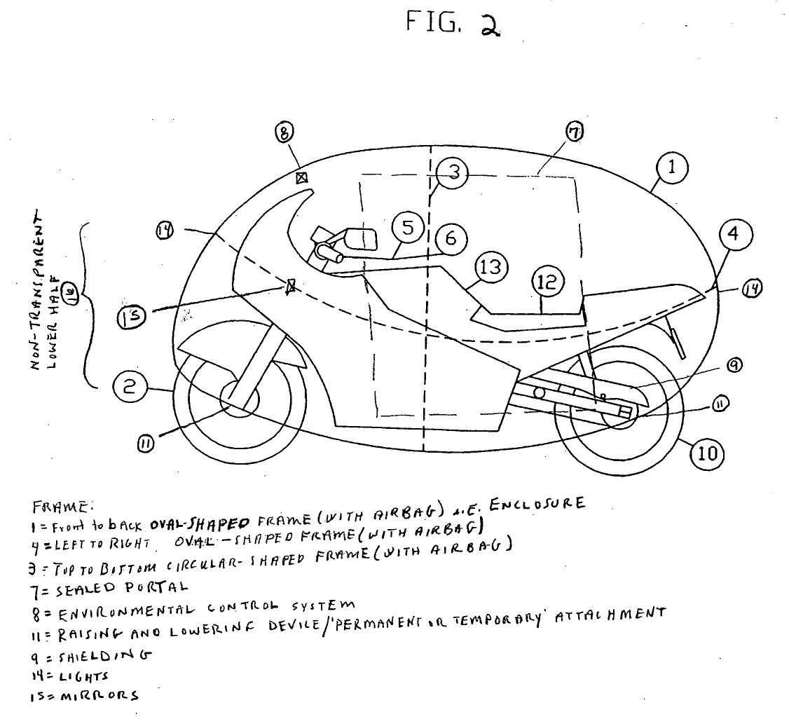

FIG. 2. Side view of an airbag equipped vehicle enclosure attached to a two-wheeled vehicle showing (1) front to back oval-shaped frame or enclosure with airbag, (4) left to right oval-shaped frame or enclosure with airbag, (3) top to bottom circular-shaped frame or enclosure with airbag, and also showing the general locations of (7) the covered or sealed portals, (8) the environment control system and defogging, deicing, and water removal/application devices, (11) the mechanized/assisted raising and lowering device(s), (9) shielding for protecting the rider and cargo from the vehicle, ( 11) permanent or temporary attachment to the vehicle, (14) lighting devices, and (15) mirrors. These features are also associated with other vehicles including and not limited to three-, and four-wheeled vehicles.

What I claim as my invention is:

1. A vehicle protective system comprising:
an enclosure for enclosing and protecting the majority of said vehicle, wherein substantially all of said enclosure is spaced from an exterior of said vehicle;
an enclosure for enclosing and protecting the majority or minority of said vehicle, wherein substantially all of said enclosure is spaced from an exterior of said vehicle;
an airbag system mounted on said enclosure for protecting said vehicle and a person or persons riding on said vehicle;
covered, sealed, and open portal(s) within or about said enclosure including permanently attached and detachable covers allowing entrance into and exiting from the enclosure.

2. a mechanized/powered/assisted system(s) for raising and lowering the enclosure for a vehicle protective system described in claim 1.

3. a bullet-proof, fire-proof, radiation-proof, chemical-resistant, or explosion-proof enclosure for a vehicle protective system described in claim 1.

4. a ‘permanent or temporary attachment mechanism for the enclosure to be attached to the vehicle (or to attachments about the vehicle) for a vehicle protection system described in claim 1.

5. accessories such as lighting devices, an environmental control system comprising a temperature and air quality control system, shields between the rider and the cargo and the vehicle, mirrors or vision or visibility enhancing devices, windshield wiper (or enclosure wiper) type devices, and defogging, deicing, and water removing or applying devices for the vehicle protective system described in claim 1.

6. a frame or structure on which the enclosure may be made for the vehicle protective system described in claim 1.

7. wire (or other material) within or about the material (polycarbon, acrylic, plexiglass, or other material) of which the enclosure is made for the enclosure described in claim 1.

8. a vehicle protective system comprising:
a non-substantially transparent enclosure for enclosing and protecting the majority of said vehicle, wherein the enclosure is spaced from the exterior of said vehicle;
an airbag system mounted on said enclosure for protecting said vehicle and a person or persons riding on said vehicle.

9. The vehicle protective system of claim 8, wherein the airbag system is located as to minimize the obstruction of visibility of the person or persons riding on said vehicle.

10. The vehicle protective system of claim 9, wherein said non-substantially transparent enclosure is tinted.

11. The vehicle protective system of claim 9, wherein at lease a portion of the airbag system is distributed around the intersection of a horizontal plane with said enclosure and wherein at least a portion of the airbag system is distributed around the intersection of a vertical plane with said enclosure.

12. The vehicle protective system of claim 9, wherein said non-substantially transparent enclosure is made of a shatter-resistant type material.

13. a vehicle protective system comprising:
a structure or frame for enclosing and protecting the majority of said vehicle, wherein substantially all of said structure is spaced from an exterior of said vehicle;
a structure or frame for enclosing and protecting the majority or minority of said vehicle, wherein substantially all of said enclosure is spaced from an exterior of said vehicle;
an airbag system mounted on said structure or frame for protecting said vehicle and a person or persons riding on said vehicle.
Covered, sealed, or open portal(s) including permanently attached or detachable covers within or about said structure or frame allowing entrance into and exiting from the enclosure.

14. A mechanized/powered/assisted system(s) for raising and lowering the enclosure for a vehicle protective system described in claim 13.

15. A bullet-proof, fire-proof, radiation-proof, chemical-resistant, or explosion-proof enclosure for a vehicle protective system described in claim 13.

16. A ‘permanent or temporary’ attachment mechanism for attaching the enclosure to the vehicle (or to attachments about the vehicle) for a vehicle protection system described in claim 13,

17. Accessories such as lighting devices, an environmental control system comprising a temperature and air quality control system, mirrors and vision or visibility enhancing devices, windshield wiper (or enclosure wiper) type devices, defogging, deicing, and water removing or applying devices, and shields between the rider and the cargo and the vehicle for the vehicle protective system described in claim 13,

18. A frame or structure on which the enclosure may be made for the vehicle protective system described in claim 20,

19. Wire (or other material) within or about the material (polycarbon, acrylic, plexiglass, or other material) of which the enclosure is made for the enclosure described in claim 20,

20. The vehicle protective system described in claims 1, 14, and 20 that is not spaced from the exterior of the vehicle.
